(19) United States
(12) Patent Application Publication
(10) Pub. No.: US 2010/0323265 A1
(43) Pub. Date: Dec. 23, 2010

(54) MEMBRANE ELECTRODE ASSEMBLY AND FUEL CELL

(76) Inventor: Kenichi TOKUDA, Miyoshi-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/788,376

(22) Filed: May 27, 2010

(30) Foreign Application Priority Data
Jun. 23, 2009 (JP) 2009-148433

(51) Int. Cl. H01M 8/24; H01M 8/10

(52) U.S. Cl. 429/452; 429/483

(57) ABSTRACT

There are provided a membrane electrode assembly in which favorable water circulation is brought about within a cell and which is superior in self-humidification performance, and a fuel cell stack comprising fuel cells comprising such a membrane electrode assembly. A membrane electrode assembly 4 comprises: an electrolyte membrane 1; and an anode-side catalyst layer 3 and a cathode-side catalyst layer 2, which are respectively disposed on both sides of the electrolyte membrane 1 and which comprise a catalyst support, in which a catalyst is supported on a conductive support, and a polymer electrolyte. With respect to this anode-side catalyst layer 3, I/C (i.e., the ratio of the mass of the polymer ionomer (I) to the mass of the conductive support (C)) is within the range of 1.0 to 2.0, EW (sulfonic acid equivalent weight) is within the range of 750 to 1,100, and polymer electrolyte thickness is within the range of 10 nm to 24 nm.

### BACKGROUND OF THE INVENTION

1. Field of the Invention

The present invention relates to a membrane electrode assembly of a fuel cell that is capable of self-humidification, and to a fuel cell stack in which fuel cells comprising this membrane electrode assembly are stacked.

2. Background Art

In a solid polymer fuel cell, a membrane electrode assembly (MEA) comprises an ion-permeable electrolyte membrane, and respective electrode catalyst layers on the anode side and the cathode side that sandwich the electrolyte membrane, an electrode assembly (MEGA: an assembly of a MEA and a gas diffusion layer (GDL)) is formed by providing on the outer side of each electrode catalyst layer a GDL for promoting gas flow and enhancing collection efficiency, and a fuel cell is formed by disposing separators on the outer side of the gas diffusion layers. In practice, a fuel cell stack is formed by stacking a number of such fuel cells in accordance with the desired power generating performance.

In the above-mentioned fuel cell, hydrogen gas or the like is supplied to the anode electrode as a fuel gas, and oxygen or air is supplied to the cathode electrode as an oxidant gas. At each electrode, the gas flows in an in-plane direction through a unique gas flow path layer or through a gas flow path groove of the separator, and the gas that is subsequently diffused at the gas diffusion layer is led by the electrode catalyst and an electrochemical reaction takes place. In this electrochemical reaction, the hydrogen ions and water produced at the anode electrode permeate the electrolyte membrane in a hydrated state to reach the cathode electrode, and water is produced at the cathode electrode. Thus, there is a problem in that, depending on how water is transported within the membrane electrode assembly or how the water is produced through the electrochemical reaction, the anode electrode is, on the one hand, susceptible to drying during the course of power generation and may, in some cases, reach dry-up, while the cathode electrode is susceptible to over-hydration and may, in some cases, reach flooding. In the case of dry-up, because the hydrogen gas is dry, the proton conductivity of the ion exchange membrane (the electrolyte membrane) drops, and the power generation performance of the fuel cell drops. In the case of flooding, water is retained in the gas diffusion layer and gas flow path layer (or the gas flow path groove of the separator) on the cathode side, the flow of oxidant gas is inhibited, and sufficient oxidant gas is not supplied to the membrane electrode assembly, as a result of which the power generation performance of the fuel cell drops.

In the above-mentioned fuel cell, both the oxidant gas supplied to the cathode side and the fuel gas supplied to the anode side are supplied into the fuel cell in a humidified state by means of a humidification module. However, due to the presence of this humidification module, the structure of the fuel cell system as a whole comprising the fuel cells, the humidification module, etc., becomes larger and, further, the weight of the system increases. For this reason, development of a fuel cell that does away with this humidification module and that is capable of in-cell self-humidification is being pursued. Here, this self-humidification is performed to circulate water within the cell through back diffusion of the water produced on the cathode side to the anode side, and transporting the accompanying water to the cathode side along with the transfer of protons from the cathode side.

However, a mode of power generation in which the humidification module is completely eliminated and both the oxidant gas and the fuel gas are supplied to the fuel cell as unhumidified atmospheres, and which is thus dependent on in-cell self-humidification would have to be considered unrealistic under current circumstances. This is because in order to enable self-humidified operation, both the ability to efficiently back diffuse the water produced on the cathode side to the anode side and the securing of a given water discharge performance or evaporation performance on the anode side must be guaranteed without fail. If thi's water discharge performance on the anode side is not secured—that is, in a state where the back diffused water is retained by the anode side electrode—back diffusion of the water generated on the cathode side is hindered, which in turn gives rise to flooding on the cathode side. Consequently, favorable water circulation within the cell cannot be achieved.

Incidentally, with regard to conventional methods for producing a catalyst layer, a generally used method is to, for example, coat the surface of a substrate, such as an electrolyte membrane, a gas diffusion layer, a Teflon sheet (Teflon: registered trademark, DuPont), etc., with a catalyst solution (catalyst ink) comprising a conductive support that supports a catalyst, a polymer electrolyte, and a diffusion solvent, and to subsequently hot-press and dry the surface of this catalyst solution. This coating operation may comprise a method of coating with a spray, a method that uses a doctor blade, etc.

When the electrode catalyst layers on both the anode side and the cathode side are thus formed with similar materials (using similar materials for the conductive support, the polymer electrolyte, and the diffusion solvent and, further, achieving a constant mixture ratio of the respective components) and in similar thicknesses, it is unclear whether or not a fuel cell in which the above-mentioned effects, that is, both efficient back diffusion of the produced water from the cathode side to the anode side and efficient water discharge performance on the anode side, are guaranteed can be obtained.

Turning to disclosed conventional techniques, Patent Document 1 discloses a fuel cell in which the cathode-side catalyst layer is of a multi-layer structure with varying I/C's (I/C: the ratio of the mass of the polymer ionomer (I) to the mass of the conductive support (C) with respect to an electrode catalyst comprising an electrode catalyst, in which a catalyst is supported by a conductive support, and a polymer electrolyte) and, further, in which the mean thickness of the anode-side catalyst layer falls within the range of 1/10 to ½ of that of the cathode side. Through such a configuration, the reaction efficiency within the membrane electrode assembly can be increased, thereby bringing about an improvement in output characteristics.

However, even this fuel cell does not go so far as to solve the above-mentioned problems, and it is still unclear whether or not a fuel cell that is capable of self-humidification with respect to an oxidant gas and a fuel gas of unhumidified atmospheres can be obtained.

[Patent Document 1] JP Patent Publication (Kokai) No. 2008-176990 A

### SUMMARY OF THE INVENTION

The present invention is made in view of the problems discussed above, and its object is to provide a membrane electrode assembly that is capable of efficiently back diffusing water produced on the cathode side to the anode side, is superior in water discharge performance or evaporation performance on the anode side, thus brings about favorable water circulation within the cell, and is superior in self-humidification performance, as well as to provide a fuel cell stack comprising fuel cells equipped therewith.

In order to achieve the object above, a membrane electrode assembly according to the present invention comprises: an electrolyte membrane; and an anode-side catalyst layer and a cathode-side catalyst layer which are respectively disposed on both sides of the electrolyte membrane and which comprise catalyst supports, in which a catalyst is supported on conductive supports, and a polymer electrolyte. With respect to the anode-side catalyst layer, I/C (the ratio of the mass of the polymer ionomer (I) to the mass of the conductive support (C)) is within the range of 1.0 to 2.0, EW (sulfonic acid equivalent weight) is within the range of 750 to 1,100 and, further, the thickness of the polymer electrolyte is within the range of 10 nm to 24 nm.

With a view to forming a fuel cell that is capable of self-humidification, a membrane electrode assembly of the present invention has characteristic features particularly in the anode-side catalyst layer thereof, where its I/C (the ratio of the mass of the polymer ionomer (I) to the mass of the conductive support (C)) is within the range of 1.0 to 2.0, its EW (sulfonic acid equivalent weight) is within the range of 750 to 1,100 and, further, its polymer electrolyte thickness is within the range of 10 nm to 24 nm.

Here, the microstructure of the catalyst layers is such that, for example, conductive supports, such as carbon particles, etc., on which a catalyst, such as platinum, an alloy thereof, etc., is supported are dispersed within a polymer ionomer. One such example may be a structure in which, for example, a plurality of carbon particles form columns across the thickness of the catalyst layer so as to be in contact with adjacent carbon particles at a portion thereof, and a polymer electrolyte of a predetermined thickness is provided in the form of a layer on the surface of the carbon forming each column. In other words, the term “polymer electrolyte thickness” refers to, with respect to a coating comprising this polymer electrolyte in the form of a layer, the distance (mean distance) from the coating surface to the conductive support.

With respect to such a structure of the catalyst layer, the present inventors have identified that when the thickness of the polymer electrolyte forming the anode-side catalyst layer is as uniform as possible across the layer as a whole and, further, is within a predetermined thickness range (10 nm to 24 nm), a fuel cell that is superior in self-humidification performance can be obtained.

With respect to the configuration of the anode-side catalyst layer described above, by virtue of the fact that I/C is within the range of 1.0 to 2.0, continuous proton paths can be formed, and continuity of power generation can be secured.

In addition, by virtue of the fact that EW (sulfonic acid equivalent weight) is within the range of 750 to 1,100, or more preferably within a range 750 to 1,000, it is possible to make it more difficult for water to adsorb onto the surface of the polymer electrolyte (which is equivalent to making it water repellent, and to a condition where the contact angle of water relative to the polymer electrolyte is less than 90 degrees). This leads to creating a difference in the concentration of water relative to the cathode-side catalyst layer, and promotes back diffusion of the produced water and the like from the cathode side.

Further, by virtue of the fact that the thickness of the polymer electrolyte is within the range of 10 nm to 24 nm, or more preferably within the range of 12 nm to 18 nm and, further, of the fact that this thickness is as uniform as possible across the layer, which comprises the polymer electrolyte, as a whole, the flow resistance (conduction resistance) up to where the fuel gas (hydrogen gas) reaches the catalyst can be made lower, which is directly linked to an improvement in the power generation performance of the fuel cell. It is noted that while it is preferable that the polymer electrolyte be thin, once it drops below 10 nm, on the other hand, the proton paths become prone to being cut off mid-layer, which is directly linked to a drop in the power generation performance of the fuel cell. Further, once it exceeds 24 nm, the increase in the above-mentioned resistance to gas flow or to proton conduction becomes pronounced, which again is directly linked to a drop in power generation performance.

It is noted that the thickness of the polymer electrolyte, particularly the mean thickness thereof, can be calculated through a formula using the particle diameter of the conductive support and the I/C that has been set (I/C=1, 2, etc.). Further, from the mass per unit area of the catalyst and the catalyst support density, the mass per unit area and the mass of the support such as carbon or the like are calculated, and the mass of the polymer electrolyte is calculated in accordance with the I/C that has been set.

In addition, the thickness of the polymer electrolyte mentioned above can be adjusted through the I/C that has been set, the particle diameter of the conductive support, and the like. Further, it has been identified by the present inventors that in order to make the thickness of this layer comprising the polymer electrolyte as uniform as possible, the temperature at the time of catalyst ink formation, the frequency imparted through ultrasound waves, etc., at the aforementioned time of formation and, further, the number of moles of an acid functional group (such as a —COOH group) on the surface of the support serve as important elements.

For example, the temperature at the time of catalyst ink formation should be 0° C. to 25° C., preferably 10° C. to 25° C., and the frequency applied to the catalyst ink should be 20 kHz to 10 GHz, preferably 100 kHz to 1,000 kHz. This is because there are concerns that if this frequency is too low, it becomes difficult to unbind clusters of a plurality of conductive supports that tend to bind with one another, and that if the frequency is too high, on the other hand, it would cause the conductive supports to agglomerate with one another.

With a membrane electrode assembly of the present invention mentioned above, by adjusting, in particular, the I/C, EW, and polymer electrolyte thickness of the anode-side catalyst layer thereof to fall within desired ranges, it is possible to promote the back diffusion of water from the cathode-side catalyst layer to the anode-side catalyst layer, as well as to improve the power generation performance of a fuel cell.

Further, in a preferred embodiment of a membrane electrode assembly according to the present invention, the anode-side catalyst layer is thinner than the cathode-side catalyst layer.

In order to form favorable water circulation within the membrane electrode assembly, it is necessary to promote the back diffusion of water from the cathode-side catalyst layer by moderately eliminating water from the anode-side catalyst layer by evaporation, etc., and keeping the water concentration in the anode-side catalyst layer low relative to the cathode-side catalyst layer.

As a configuration to that end, by making the layer thickness of the anode-side catalyst layer thinner relative to the cathode-side catalyst layer, it is possible to make the distance required for water to evaporate as short as possible, and to thus promote the evaporation thereof.

Further, with respect to an embodiment in which the anode-side catalyst layer is thinner than the cathode-side catalyst layer, the present inventors have identified that the thickness of the anode-side catalyst layer should preferably be in the range of 10% to 60% of that of the cathode-side catalyst layer.

It is undesirable for the thickness of the anode-side catalyst layer to be less than 10% of that of the cathode-side catalyst layer, as the anode-side surface of the electrolyte membrane would become prone to exposure, and the electrolyte membrane to degradation and damage.

On the other hand, once it exceeds 60%, it becomes difficult to establish between the anode-side catalyst layer and the cathode-side catalyst layer a difference in water concentration that is sufficient to ensure favorable back diffusion of water from the cathode-side catalyst layer.

It is noted that in fabricating the above-mentioned membrane electrode assembly, a catalyst ink is prepared by blending a polymer electrolyte, a dispersion solvent and a catalyst support in a desired blending ratio, a substrate is, for example, coated therewith, and annealing and drying are performed at a desired temperature to form the cathode-side catalyst layer and the anode-side catalyst layer on the surfaces of the substrate. Here, this substrate may be any of an electrolyte membrane, a gas diffusion layer (gas permeable layer), and a support film.

It is noted that the structure of a fuel cell comprising a membrane electrode assembly of the present invention mentioned above includes both an embodiment comprising a gas diffusion layer comprising a diffusion layer substrate and a collector layer on both the anode side and the cathode side of the membrane electrode assembly (MEA), as well as an embodiment in which either the anode side or the cathode side comprises only the collector layer (i.e., in which the diffusion layer substrate is done away with). Also, in the present specification, both of these embodiments are referred to as electrode assemblies (MEGA). In addition, there is naturally included an embodiment in which separators with a gas flow path groove formed therein are directly disposed on both sides of the electrode assembly, as well as an embodiment in which a gas flow path layer (a metallic porous body such as an expanded metal, etc.) is disposed between a so-called flat-type separator and the electrode assembly. Further, the term “gas permeable layer” is used to refer to both a gas diffusion layer and a gas flow path layer. Therefore, in a cell structure that does not comprise a gas flow path layer, the term “gas permeable layer” would refer to a “gas diffusion layer,” whereas in a cell structure comprising both a gas diffusion layer and a gas flow path layer, the term “gas permeable layer” would refer to one or both of the “gas diffusion layer” and the “gas flow path layer.”

As can be understood from the description above, according to a membrane electrode assembly of the present invention and to a fuel cell stack in which fuel cells comprising such a membrane electrode assembly are stacked, the back diffusion of water from the cathode-side catalyst layer to the anode-side catalyst layer becomes favorable, and the evaporation of water at the anode-side catalyst layer, etc., also becomes favorable. Further, the thickness of the polymer electrolyte in the periphery of the catalyst support forming the anode-side catalyst layer is adjusted to fall within a desired range, and that thickness is as uniform as possible across the layer as a whole. As a result, it is possible to retain proton paths and to keep the gas flow resistance against the fuel gas in the polymer electrolyte as low as possible, and a fuel cell stack that is superior in self-humidification performance and power generation performance is obtained.

### BRIEF DESCRIPTION OF THE DRAWINGS

FIG. 1 is a vertical sectional view of an embodiment of an electrode assembly including a membrane electrode assembly of the present invention.

FIG. 2 is an enlarged view of portion II in FIG. 1 and is a schematic view showing the microstructure of catalyst layers, while at the same time showing the flow of produced water, the evaporation of water, and the flow of protons.

FIG. 3 is a graph showing experiment results comparing the power generation performance of fuel cells comprising an anode-side catalyst layer comprising the basic configuration of the present invention (examples) with that of a comparative example of a conventional structure.

FIG. 4 is a graph showing the results of an experiment for defining the thickness of an anode-side catalyst layer and a range therefor, comparing the power generation performance of fuel cells comprising an anode-side catalyst layer comprising the basic configuration of the present invention (examples) with that of a comparative example of a conventional structure.

FIG. 5 is a graph showing the results of a further experiment for defining the thickness of an anode-side catalyst layer and a range therefor, comparing power generation performance among fuel cells comprising an anode-side catalyst layer comprising the basic configuration of the present invention (examples).

FIG. 6 shows the results of an experiment and an analysis for defining the thickness range of the polymer electrolyte of an anode-side catalyst layer and a graph based thereon, comparing the power generation performance of each fuel cell while varying the thickness of the polymer electrolyte.

### DESCRIPTION OF SYMBOLS

1: electrolyte membrane, 2: cathode-side catalyst layer, 3: anode-side catalyst layer, 4: membrane electrode assembly, 5: cathode-side gas diffusion layer (gas permeable layer), 6: anode-side gas diffusion layer (gas permeable layer), 10: electrode assembly, 51: diffusion layer substrate, 52: collector layer (MPL), and 7A, 7B: protective film.

### DETAILED DESCRIPTION OF THE PREFERRED EMBODIMENTS

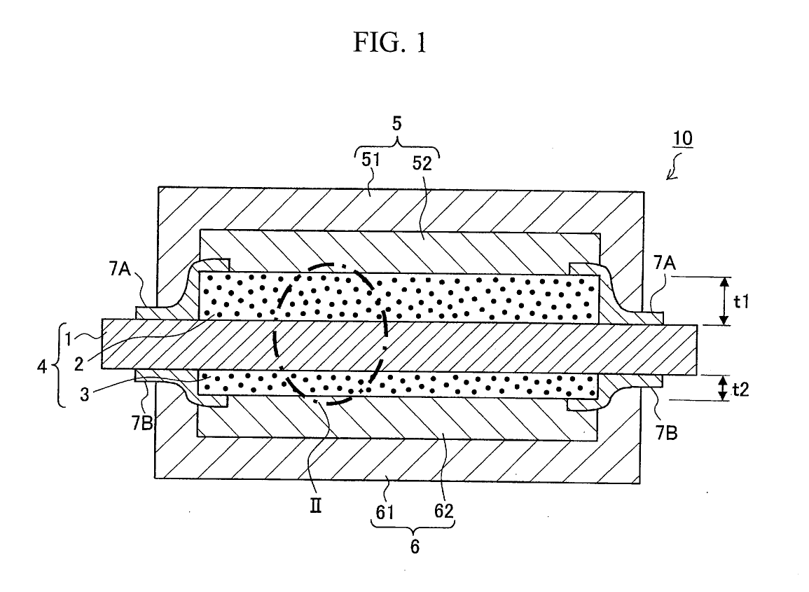

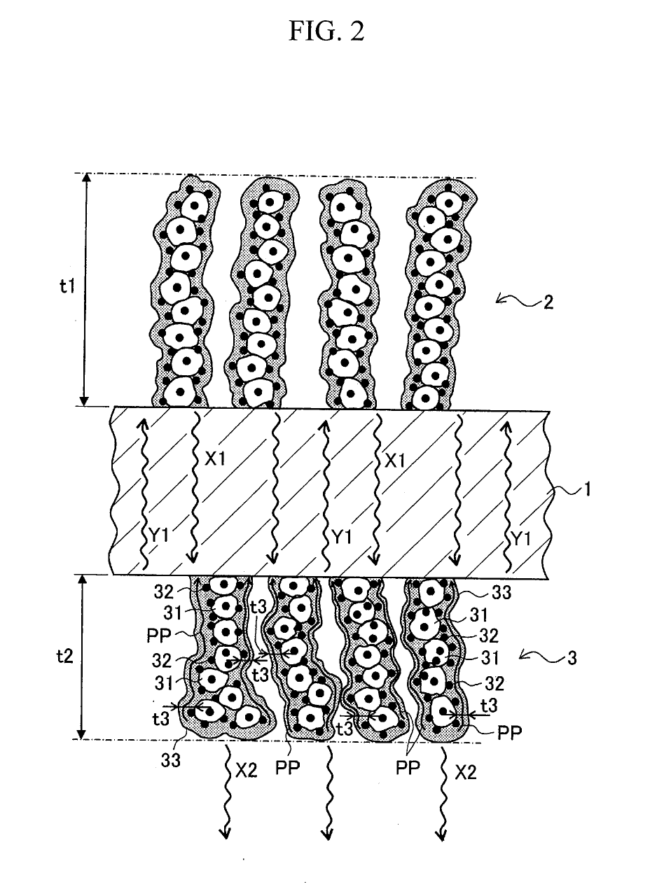

Embodiments of the present invention are described below with reference to the drawings. FIG. 1 is a vertical sectional view of an embodiment of an electrode assembly including a membrane electrode assembly of the present invention. FIG. 2 is an enlarged view of portion II in FIG. 1 and is a schematic view showing the microstructure of catalyst layers, while at the same time showing the flow of produced water, the evaporation of water and the flow of protons.

An electrode assembly 10 of the fuel cell shown in FIG. 1 comprises: a membrane electrode assembly 4 formed with an electrolyte membrane 1, a cathode-side catalyst layer 2 and an anode-side catalyst layer 3; and gas diffusion layers 5 and 6 (gas permeable layers) on the cathode side and the anode side sandwiching the membrane electrode assembly 4. It is noted that this electrode assembly 10 is sandwiched by gas flow path layers (gas permeable layers, metallic porous bodies) not shown in the drawings on the cathode side and the anode side, and further, the gas flow path layers are sandwiched by, for example, separators of a three-layer structure not shown in the drawings to form the fuel cell. In addition, with respect to a fuel cell comprising the electrode assembly 10 shown in the drawing and, further, with respect to a fuel cell stack in which such fuel cells are stacked, by having each fuel cell comprise the membrane electrode assembly 4 shown in the drawings, it is possible to obtain a self-humidifying cell in which both the fuel gas and the oxidant gas supplied to each fuel cell are unhumidified atmospheres, and in which each fuel cell thus executes in-cell humidification and humidity retention on its own.

The catalyst layers 2 and 3 are smaller in area as compared to the electrolyte membrane 1. Therefore, at the periphery of the catalyst layers 2 and 3 on both sides of the electrolyte membrane 1 are formed exposed areas where the catalyst layers 2 and 3 are not present. Respective protective films 7A and 7B of the cathode side and the anode side are disposed on these exposed areas to protect the exposed areas of the electrolyte membrane 1 from being pierced by the fuzz protruding from the gas diffusion layers 5 and 6.

Here, the electrolyte membrane 1 of the membrane electrode assembly 4 is formed of, for example, a fluorinated ion-exchange membrane having a sulfonic acid group or a carbonyl group, a non-fluorinated polymer such as substituted phenylene oxide, sulfonated polyaryl ether ketone, sulfonated polyaryl ether sulfone, sulfonated phenylene sulfide, etc.

In addition, both the cathode-side catalyst layer 2 and the anode-side catalyst layer 3 are formed by preparing a catalyst ink by mixing conductive supports (carbon supports in the form of particles, etc.) on which a catalyst is supported, a polymer electrolyte (ionomer) and a dispersion solvent (organic solvent), forming a film by spreading this on a substrate such as the electrolyte membrane 1, the gas diffusion layer 5, 6 or the like, in the form of a layer with, for example, a coating blade, and drying it in a hot-air drying oven or the like. It is noted that, in preparing the catalyst ink, the external temperature during the preparation thereof should be adjusted to within a range of 0° C. to 25° C., preferably to within a range of 10° C. to 25° C. Further, an ultrasonic wave, or the like, of a frequency of 20 kHz to 10 GHz, preferably 100 kHz to 1,000 kHz, should be applied to the catalyst ink. The purpose of both of the above is to make the thickness of the polymer electrolyte, which is formed around the catalyst support of the catalyst layer and which becomes a proton path, even. Further, the prepared catalyst ink should be stored inside a refrigerator, etc., like under an atmosphere of a temperature of around 0° C. to 10° C.

Here, the polymer electrolyte forming the catalyst ink may include: an ion-exchange resin whose skeleton comprises an organic fluorine-containing polymer, which is a proton-conducting polymer, such as, for example, perfluorocarbon sulfonic acid resin; a sulfonated plastic electrolyte such as sulfonated polyether ketone, sulfonated polyether sulfone, sulfonated polyether ether sulfone, sulfonated polysulfone, sulfonated polysulfide, sulfonated polyphenylene, etc.; a sulfoalkylated plastic electrolyte such as sulfoalkylated polyether ether ketone, sulfoalkylated polyether sulfone, sulfoalkylated polyether ether sulfone, sulfoalkylated polysulfone, sulfoalkylated polysulfide, sulfoalkylated polyphenylene, etc.; and the like. Commercially available materials include Nafion (registered trademark, product of DuPont), Flemion (registered trademark, product of Asahi Glass Co., Ltd.), etc. In addition, examples of the dispersion solvent may include: alcohols such as methanol, ethanol, 1-propanol, 2-propanol, ethylene glycol, diethylene glycol, etc.; esters such as acetone, methyl ethyl ketone, dimethyl formamide, dimethyl imidazolidinone, dimethyl sulfoxide, dimethylacetamide, N-methylpyrrolidone, propylene carbonate, ethyl acetate, butyl acetate, etc.; various aromatic solvents; and various halogenated solvents. Further, these may be used alone or in mixture. Further, with respect to the conductive support on which the catalyst is supported, examples of this conductive support may include, besides carbon materials such as carbon black, carbon nanotubes, carbon nanofibers, etc., carbon compounds such as silicon carbide, etc. For the catalyst (metal catalyst), one of, for example, platinum, platinum alloys, palladium, rhodium, gold, silver, osmium, iridium, etc., may be used, where the use of platinum or a platinum alloy is preferable. Further, examples of this platinum alloy may include, for example, alloys of platinum and at least one of aluminum, chromium, manganese, iron, cobalt, nickel, gallium, zirconium, molybdenum, ruthenium, rhodium, palladium, vanadium, tungsten, rhenium, osmium, iridium, titanium, and lead.

In the example shown in the drawings, the anode-side catalyst layer 3 is thinner than the cathode-side catalyst layer 2, and is of a thickness of, for example, about 10% to 60% of the thickness of the cathode-side catalyst layer 2.

Further, the gas diffusion layers 5 and 6 respectively comprise diffusion layer substrates 51 and 61, and collector layers 52 and 62 (MPL). As for the diffusion layer substrates 51 and 61, while they are not limited to anything in particular so long as they have low electrical resistance and are capable of current collection, examples thereof may include those that are chiefly made of a conductive inorganic material. Examples of this conductive inorganic material may include a calcined product of polyacrylonitrile, a calcined product of pitch, carbon materials such as graphite, expanded graphite, etc., nanocarbon materials thereof, stainless steel, molybdenum, titanium, etc. In addition, the conductive inorganic material of the diffusion layer substrates is not limited to any particular form, and may be used in the form of fibers or particles, for example. However, for purposes of gas permeability, inorganic conductive fibers, particularly carbon fibers, are preferable. As the diffusion layer substrate using an inorganic conductive fiber, one that has the structure of a woven cloth or a nonwoven cloth may be used, examples of which include carbon paper, carbon cloth, etc. As for woven cloths, there are no particular limitations and examples may include figured cloth, plain cloth, etc., and examples of a nonwoven cloth may include those made by a paper making method, a water-jet punch method, etc. Further, examples of this carbon fiber may include a phenolic carbon fiber, a pitch-based carbon fiber, a polyacrylonitrile (PAN) based carbon fiber, a rayon-based carbon fiber, etc. Further, the collector layers 62 and 52 serve the role of electrodes that collect electrons from the anode-side and cathode-side catalyst layers 3 and 2, while at the same time producing a water-repellent effect for discharging the produced water, and may be formed from such conductive materials as platinum, palladium, ruthenium, rhodium, iridium, gold, silver, copper, compounds or alloys thereof, conductive carbon materials, etc.

In FIG. 2, particularly with respect to the anode-side catalyst layer 3, catalyst supports in which catalysts 32 are supported on the surface of conductive supports 31 are arranged, for example, in columns in a mutually contacting or separated posture. A coating comprising a continuous polymer electrolyte 33 is formed on the surface of the plurality of catalyst supports, and this forms a proton path PP. It is noted that the arrangement of the catalyst supports need not be a columnar arrangement as illustrated in the drawing and may instead be such that the catalyst supports are randomly dispersed in a mutually separated posture, so long as, in either case, the surface of each of the plurality of catalyst supports is covered with a coating comprising a continuous polymer electrolyte, and so long as this coating forms a proton path.

When a fuel gas is supplied to the anode-side catalyst layer 3, protons and the accompanying water that accompanies them are conducted to the cathode-side catalyst layer 2 (Y1 direction) via the proton paths PP and the electrolyte membrane 1.

On the other hand, the water produced at the cathode-side catalyst layer 2 is back-diffused to the anode-side catalyst layer 3 (X1 direction) via the electrolyte membrane 1. Water circulation within the fuel cell is thus formed by way of the transport of this accompanying water and the back-diffusion of the produced water.

Here, in order to promote the back-diffusion of water from the cathode-side catalyst layer 2 to the anode-side catalyst layer 3 with a view to achieving favorable water circulation within the cell, it is necessary that the evaporation of water from the anode-side catalyst layer 3 be carried out smoothly.

As a simple structure for producing such an effect, thickness t2 of the anode-side catalyst layer 3 is made to be less than thickness t1 of the cathode-side catalyst layer 2.

In addition, it is preferable that thickness t3 of the polymer electrolyte 33 have as low a value as possible so as to make the resistance against the fuel gas up to its reaching the catalysts as small as possible, while being of such a thickness that there would be no risk of the proton paths PP shown in the drawing being cut off midway. An example of such a thickness would be 10 nm to 24 nm, or more preferably 12 nm to 18 nm.

Further, with respect to the continuous polymer electrolyte 33 shown in the drawing, for example, it is preferable for purposes of power generation performance that it be formed, as a whole, in as uniform a thickness as possible. To that end, it is preferable to take such measures as adjusting the temperature during catalyst ink formation within the above-mentioned temperature range, adjusting the frequency imparted by an ultrasonic wave, etc., during such formation within the above-mentioned frequency range and, further, adjusting the acid functional group (a —COOH group, etc.) on the surface of the supports to the desired number of moles, and so forth.

It is noted that in order to maintain continuous proton paths, it is preferable that the I/C (i.e., the ratio of the mass of the polymer ionomer (I) to the mass of the conductive support (C)) of the anode-side catalyst layer 3 be adjusted to within the range of 1.0 to 2.0.

In addition, with a view to promoting the evaporation of water at the anode-side catalyst layer 3, it is preferable that, besides the above-mentioned thicknesses of the catalyst layers, water not be readily adsorbed onto the polymer electrolyte, that is, that EW (sulfonic acid equivalent weight) be adjusted to fall within the range of 750 to 1,100, more particularly 750 to 1,000, so that the contact angle thereof would be less than 90 degrees.

[Experiment Comparing the Power Generation Performance of Fuel Cells (Examples) Having an Anode-Side Catalyst Layer Comprising the Basic Configuration of the Present Invention with that of a Comparative Example of a Conventional Structure, and Results Thereof]

The present inventors produced samples of fuel cells, varying the catalyst support density of the catalyst supports, the polymer electrolyte, I/C, etc., and the generated voltage in accordance with the current density of each fuel cell was measured. Here, the respective fuel cells of Comparative Example 1 and Examples 1 to 5 all conform to the common standard specifications indicated in Table 1 below and the specifications of the anode-side catalyst layer indicated in Table 2 below.

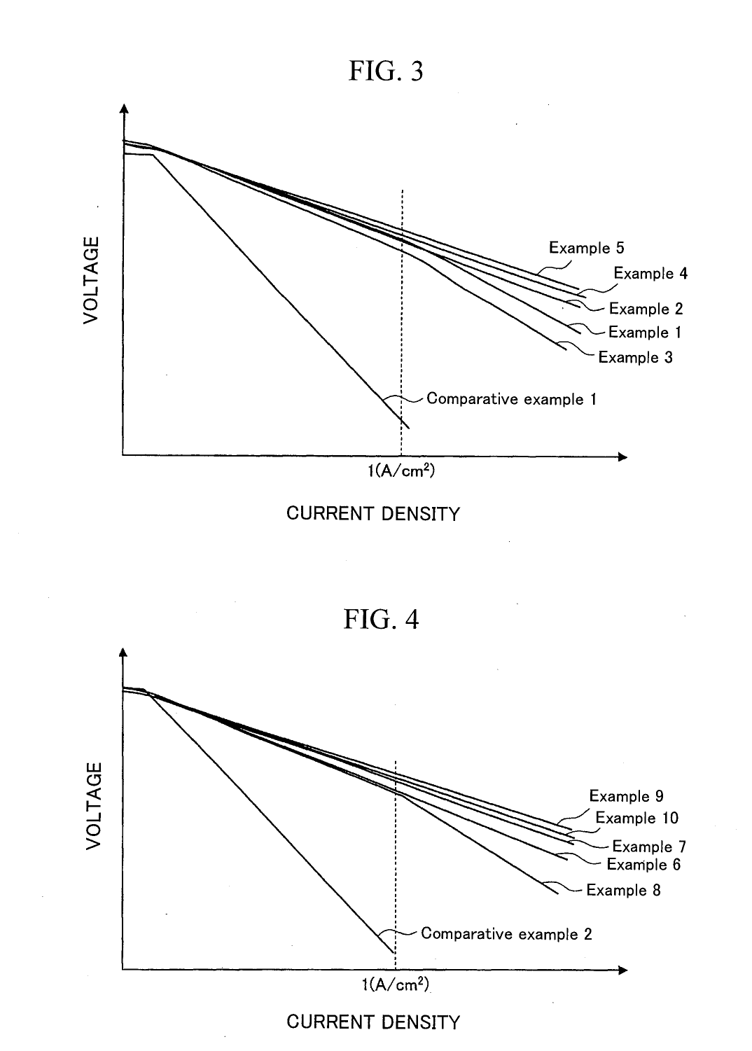

It is noted that while the anode-side catalyst layers of the respective fuel cells of Examples 1 to 5 vary in terms of specifications, they all have in common the fact that the EW of the polymer electrolyte (ionomer) is either 1,000 or 1,100 (g/eq) (i.e., falling within the range of 750 to 1,100), the fact that I/C is within the range of 1 to 2, and the fact that the thickness of the polymer electrolyte (i.e., thickness t3 in FIG. 2) is within the range of 10 nm to 24 nm. Comparative Example 1 is such that one of the aforementioned specifications deviates from these numerical ranges. Results of a power generation test for Comparative Example 1 and Examples 1 to 5 are presented in FIG. 3 and in the bottom row of Table 2. Here, the generated voltage is normalized with respect to the value of comparative Example 1 under a condition where the current density is 1 (A/cm²) as a baseline value, and the voltages of Examples 1 to 5 are expressed as ratios relative to this baseline value.

TABLE 1

| Electrolyte Membrane | | N111 |
|---|---|---|
| Cathode-Side | Catalyst | Pt |
| Catalyst Layer | Support Density | 60% |
| | Mass per Unit Area | 0.4 mg/cm² |
| | I/C | 0.8 |
| | Thickness | 10 μm |
| Gas Diffusion Layer of | Substrate | TGP060 |
| Both Electrodes | Paste | BMAB:PTFE = 6:4 |
| | Total Mass per Unit Area | 10 mg/cm² |

TABLE 2

| | | | | | | | Comp. |
|---|---|---|---|---|---|---|---|
| | | Ex. 1 | Ex. 2 | Ex. 3 | Ex. 4 | Ex. 5 | Ex. 1 |
| Anode-Side | Catalyst | 10 | 30 | 10 | 30 | 30 | 10 |
| Catalyst | Support | | | | | | |
| Layer | Density (%) | | | | | | |
| | Pt Mass | 0.02 | 0.05 | 0.05 | 0.05 | 0.05 | 0.02 |
| | per Unit Area | | | | | | |
| | (mg/cm²) | | | | | | |
| | Ionomer | DE2021 | DE2021 | DE2021 | DE2021 | DE2020 | DE2021 |
| | I/C | 1.2 | 1.2 | 1.2 | 1.1 | 1.1 | 0.7 |
| | Ionomer | 14 | 14 | 14 | 13 | 13 | 9 |
| | Thickness | | | | | | |
| | (nm) | | | | | | |
| | Anode- | 10 | 5 | 20 | 5 | 5 | 10 |
| | Side | | | | | | |
| | Catalyst | | | | | | |
| | Layer | | | | | | |
| | Thickness | | | | | | |
| | (μm) | | | | | | |
| Power | Voltage | 3.5 | 3.51 | 3.1 | 4.0 | 4.25 | 1 |
| Generation | (1 A/cm²) | | | | | | |
| Performance | | | | | | | |
| Test Result | | | | | | | |

It is noted that both DE2020 and 2021 are ionomers produced by DuPont, and that because their IECs (ion exchange capacity: meq/g) are approximately 1 and 0.9, respectively, their EWs, which are inverses of IEC, are approximately 1,000 g/eq and 1,100 g/eq, respectively.

From the experiment results relating to power generation performance in FIG. 3 and Table 2, it is demonstrated that among Examples 1 to 5, the fuel cell of Example 5 exhibits the highest power generation performance. In addition, even with respect to the fuel cell of Example 3 with the lowest power generation performance among Examples 1 to 5, power generation performance is approximately 3.1 times as high when the current density is 1 (A/cm²) for the fuel cell of Comparative Example 1, and as for Example 5, a result that is 4.25 times as high is attained. Further, the fact that the improvement in power generation performance relative to the comparative example becomes even more pronounced in the high current density region exceeding 1 (A/cm²) can readily be confirmed by comparing the relevant graphs.

In Examples 1 to 5, reasons for the fact that the power generation performance of the fuel cell of Example 5 was the highest include: the fact that the anode-side catalyst layer's I/C is 1.1 (falling within the range of 1.0 to 2.0); the fact that EW (sulfonic acid equivalent weight) is 1,000 g/eq (falling within the range of 750 to 1,100); the thickness of the ionomer is 14 nm (falling within the range of 10 nm to 24 nm); and the fact that the thickness of the anode-side catalyst layer is less than that of the cathode-side catalyst layer.

Further, comparing the experiment results of Example 4 and Example 5, the EW of Example 4 is 1,100, and to the extent that it is higher than the value of 1,000 for Example 5, there is a slight difference in power generation performance.

In addition, for Comparative Example 1, it is inferred that power generation performance is significantly lower as compared to each of Examples 1 to 5 due to the fact that proton paths are cut off midway and proton conduction resistance is high because I/C is small, with a value of less than 1, and the thickness of the ionomer is less than 10 nm.

[Experiment for Defining the Thickness Range of the Anode-Side Catalyst Layer and in which Power Generation Performance is Compared Among Fuel Cells Having an Anode-Side Catalyst Layer Comprising the Basic Configuration of the Present Invention (Examples) and a Comparative Example of a Conventional Structure, and Results Thereof]

The present inventors further produced samples of fuel cells of Examples 6 to 10 changing, among the standard specifications presented in Table 1, the support density of the cathode-side catalyst layer from 60% to 45% and, further, changing the thickness thereof from 10 μm to 18 μm, while maintaining the same specifications as those in Table 2 for the anode-side catalyst layer. The standard specifications for the cathode-side catalyst layer as changed are indicated in Table 3 below. Further, in this experiment, Comparative Example 2 is such that the thickness of the anode-side catalyst layer of Comparative Example 1 is changed from 10 μm to 20 μm, and the catalyst support density from 10% to 5%, and a sample of a fuel cell corresponding thereto was produced. It is noted that Examples 6 to 10 correspond to Examples 1 to 5, respectively, and differ only in terms of the specification of the cathode-side catalyst layer of the fuel cell.

TABLE 3

| Electrolyte Membrane | | N111 |
|---|---|---|
| Cathode-Side | Catalyst | Pt |
| Catalyst Layer | Support Density | 45% |
| | Mass per Unit Area | 0.4 mg/cm² |
| | I/C | 0.8 |
| | Thickness | 18 μm |
| Gas Diffusion Layer of | Substrate | TGP060 |
| Both Electrodes | Paste | BMAB:PTFE = 6:4 |
| | Total Mass per Unit Area | 10 mg/cm² |

Results of a power generation test for the respective fuel cells of Examples 6 to 10 and Comparative Example 2 are indicated in FIG. 4 and Table 4 below. Here, the generated voltage is, as in Table 2 and FIG. 3, normalized with respect to the value of Comparative Example 2 under a condition where the current density is 1 (A/cm²) as a baseline value, and the voltages of Examples 6 to 10 are expressed as ratios relative to this baseline value.

TABLE 4

| Anode-Side Catalyst | | | | | | | Comp. |
|---|---|---|---|---|---|---|---|
| Layer Thickness (nm) | | Ex. 6 | Ex. 7 | Ex. 8 | Ex. 9 | Ex. 10 | Ex. 2 |
| Power | Voltage | 3.25 | 3.5 | 3.0 | 3.9 | 3.75 | 1 |
| Generation | (1 A/cm²) | | | | | | |
| Performance | | | | | | | |
| Experiment | | | | | | | |
| Result | | | | | | | |

From the experiment results relating to power generation performance presented in FIG. 4 and Table 4, it is demonstrated that Example 8, whose anode-side catalyst layer thickness is greatest among Examples 6 to 10, has the lowest power generation performance. However, it is demonstrated that the power generation performance of Example 8 is nonetheless approximately 3.0 times as high at a current density of 1 (A/cm²) relative to Comparative Example 2 with a comparable anode-side catalyst layer thickness.

Further, the power generation performance of Examples 7, 9, and 10, whose anode-side catalyst layer thicknesses are of the lowest values among Examples 6 to 10, is 3.5, 3.9, and 3.75 times as high, respectively, relative to Comparative Example 2 at a current density of 1 (A/cm²), and it is thus demonstrated that marked improvements in performance are attained.

It is inferred that this is due to the fact that favorable water circulation is formed within the cell even when both the supplied fuel gas and oxidant gas are unhumidified atmospheres and favorable proton conduction is secured as a result of the fact that the evaporation of water from the anode-side catalyst layer is promoted and the back diffusion of water from the cathode-side catalyst layer is promoted (thus preventing any inhibition of the flow of oxidant gas caused by a build-up of water in the cathode-side catalyst layer) by virtue of the fact that the anode-side catalyst layer is as thin as possible.

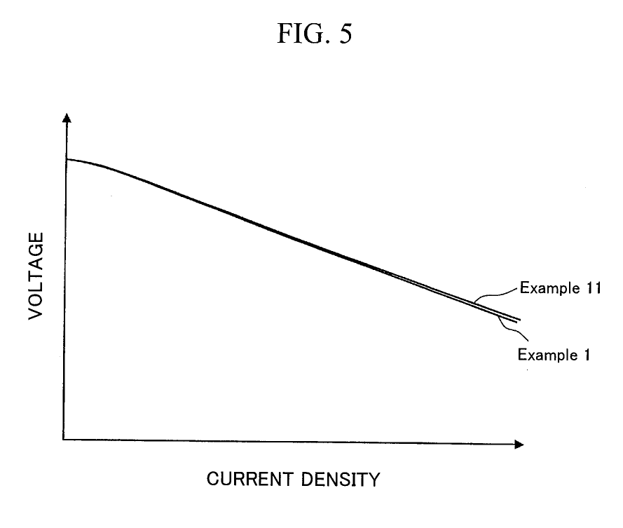

The present inventors further produced a separate sample of a fuel cell (Example 11) varying the specifications of the cathode-side catalyst layer and the anode-side catalyst layer. An experiment comparing the power generation performance of Example 11 with that of Example 1 discussed above was conducted. These specification changes and experiment results are respectively presented in Table 5 below and in FIG. 5.

TABLE 5

| Electrolyte Membrane | | N111 |
|---|---|---|
| Cathode-Side | Catalyst | Pt |
| Catalyst Layer | Support Density | 50% |
| | Mass per Unit Area | 0.4 mg/cm² |
| | I/C | 0.8 |
| | Thickness | 15 μm |
| Gas Diffusion Layer of | Substrate | TGP060 |
| Both Electrodes | Paste | BMAB:PTFE = 6:4 |
| | Total Mass per Unit Area | 10 mg/cm² |
| Cathode-Side | Catalyst Support Density | 30 |
| Catalyst Layer | (%) | |
| | Pt Mass per Unit Area | 0.05 |
| | (mg/cm²) | |
| | Ionomer | DE2021 |
| | I/C | 1.2 |
| | Ionomer Thickness (nm) | 14 |
| | Anode-Side Catalyst | 2 |
| | Layer Thickness (nm) | |

From FIG. 5, it can be seen that power generation performance is comparable between Example 1 and Example 11. This signifies the fact that the thickness of the anode-side catalyst layer may be reduced to approximately 2 μm.

Further, it may be said that it is demonstrated through the three experiments above that it is preferable that the anode-side catalyst layer be thinner than the cathode-side catalyst layer. In other words, it is demonstrated that, when the thickness of the cathode-side catalyst layer is 10 μM, the power generation performance of Examples 2, 4, and 5, whose anode-side catalyst layers are thinnest as indicated in Table 1, is relatively higher compared to FIG. 3, and it is demonstrated that, when the thickness of the cathode-side catalyst layer is 18 μm, the power generation performance of Examples 7, 9, and 10, whose anode-side catalyst layers are thinnest, is likewise relatively higher compared to FIG. 4.

In addition, with respect to the ratio of the thickness of the anode-side catalyst layer to the thickness of the cathode-side catalyst layer for each fuel cell of Examples 1 to 11, it may be concluded as follows: For cases where the anode-side catalyst layer is thinner relative to the cathode-side catalyst layer, the thickness of the anode-side catalyst layer (2 μm, 5 μm, 10 μm) is approximately 10% to 60% of the thickness of the cathode-side catalyst layer (10 μm, 15 μm, 18 μm), and these values of 10% and 60% should be defined as lower and upper limit values of the thickness of the anode-side catalyst layer relative to the thickness of the cathode-side catalyst layer, that is, the thickness of the anode-side catalyst layer should be set within the range of 10% to 60% of the thickness of the cathode-side catalyst layer.

[Formula for Calculating Polymer Electrolyte Thickness]

According to the present inventors, the thickness of the polymer electrolyte (ionomer) mentioned above may be defined based on the calculation formula below.

In other words, assuming t is the thickness of the ionomer, r the mean diameter of the conductive supports (carbon particles, etc.), Ric the I/C, ρc the specific gravity of the conductive support, ρi the specific gravity of the ionomer, Sc the surface area of the conductive support, Mc the mass of the conductive support, and Mi the mass of the ionomer, then Equation 5 for calculating thickness t of the ionomer may be derived from the following four equations. By adjusting the parameters of Equation 5, it is possible to define the desired mean thickness of the ionomer.

Mc=4/3·ρc·π·r³ (Equation 1)

Mi=Ric·Mc (Equation 2)

Mi=4/3·ρi·π{(r+t)³−r³}≈4/3·ρi·π·r³{(1+3t/r)−1}=4ρiπr²t (Equation 3)

where, given r=1 μm to 50 μm and t=1 nm to 25 nm, it follows that r>>t, and approximation is therefore applied in Equation 3.

ρc=ρi (Equation 4)

t=Ric·r/3 (Equation 5)

[Experiment and Analysis Comparing Power Generation Performance Among Fuel Cells while Varying the Thickness of the Polymer Electrolyte, and Results Thereof]

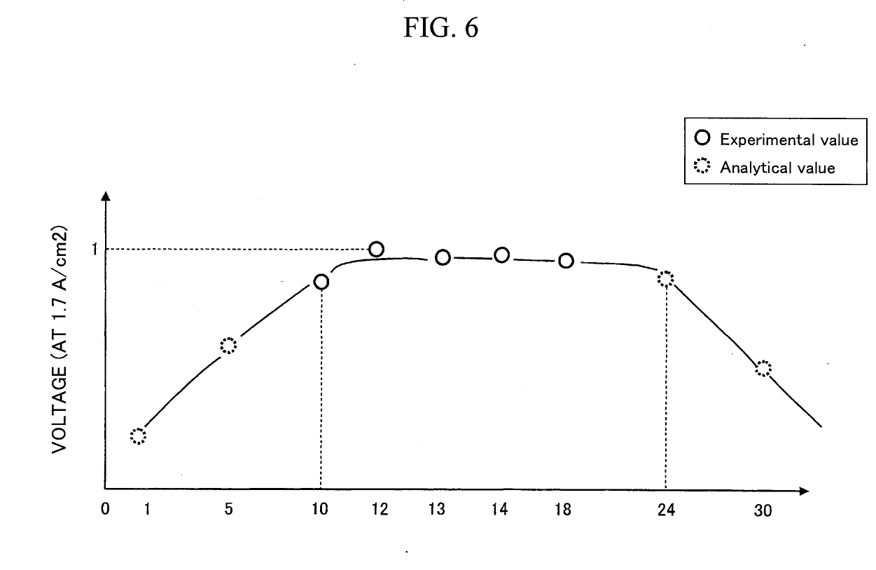

With a view to defining the range for the thickness of the polymer electrolyte (ionomer) of the anode-side catalyst layer, the present inventors further produced sample fuel cells (Examples 12 to 15) whose standard specifications are compliant with Table 1 and for which the specification of the anode-side catalyst layer is as presented below in Table 6 where the thickness of the ionomer is varied. The solid-line circles in FIG. 6 represent experiment results for Examples 12 to 15 as well as Example 1. In addition, with a view to clearly defining the preferred numerical range for ionomer thickness, fuel cells comprising anode-side catalyst layers having ionomer thicknesses of a range that could not be guaranteed in the experiment were modeled on a computer. The broken-line circles in FIG. 6 represent results of calculating power generation performance through analysis. Further, experiment and analysis results for the power generation performance thereof are presented in Table 7 below (where “analysis” is abbreviated as “An.”). It is noted that the power generation performance experiment and analysis results in FIG. 6 and Table 7 represent values for a case of a high current density of 1.7 (A/cm²).

TABLE 6

| | | Ex. 1 | Ex. 12 | Ex. 13 | Ex. 14 | Ex. 15 |
|---|---|---|---|---|---|---|
| Anode- | Catalyst | 10 | 10 | 10 | 10 | 10 |
| Side | Support | | | | | |
| Catalyst | Density (%) | | | | | |
| Layer | Pt Mass per | 0.02 | 0.02 | 0.02 | 0.02 | 0.02 |
| | Unit Area | | | | | |
| | (mg/cm²) | | | | | |
| | Ionomer | DE2021 | DE2021 | DE2021 | DE2021 | DE2021 |
| | I/C | 1.2 | 1.1 | 1.0 | 1.0 | 1.0 |
| | Ionomer | 14 | 13 | 12 | 18 | 10 |
| | Thickness | | | | | |
| | (nm) | | | | | |
| | Anode-Side | 10 | 10 | 10 | 10 | 10 |
| | Catalyst Layer | | | | | |
| | Thickness (μm) | | | | | |

TABLE 7

| | Ionomer Thickness | | | | | | | | |
|---|---|---|---|---|---|---|---|---|---|
| | (nm) | | | | | | | | |
| | 1 | 5 | 10 | 12 | 13 | 14 | 18 | 24 | 30 |
| Analytical | An. | An. | Ex. 1 | Ex. 12 | Ex. | Ex. | Ex. | An. | An. |
| Value/Experimental | | | | | 13 | 14 | 14 | | |
| Value (Example) | | | | | | | | | |
| Voltage (1.7 A/cm²) | 0.20 | 0.55 | 0.90 | 1.00 | 0.98 | 0.99 | 0.97 | 0.91 | 0.48 |

From Table 7 and FIG. 6, with respect to ionomer thickness, that is, the thickness from the surface of the ionomer in the form of a layer to the conductive support (mean thickness), which corresponds to thickness t3 in FIG. 2, it is demonstrated that points of inflexion are reached at a lower limit value of 10 nm and an upper limit value of 24 nm, high power generation voltages are observed in a substantially flat manner within the range therebetween, and the power generation voltage drops sharply at 10 nm and 24 nm.

With reference to FIG. 6 in further detail, it can be seen that there is formed a region of highest power generation voltage within an ionomer thickness range of 12 nm to 18 nm. Thus, it is demonstrated that the ionomer of the anode-side catalyst layer should preferably be formed with a thickness of 10 nm to 24 nm, or more preferably with a thickness of 12 nm to 18 nm.

Further, an ionomer so formed within this range is, as shown in FIG. 2 for example, formed in the form of a layer on the surface of a plurality of catalyst supports. As already discussed, it is preferable that it be formed as evenly as possible across this layer as a whole.

From the various experiments and analyses above, it can be seen that according to a fuel cell comprising a membrane electrode assembly comprising an anode-side catalyst layer that is a characteristic feature of the present invention (including the feature where layer thickness is adjusted in relation to the cathode-side catalyst layer) and to a fuel cell stack in which such fuel cells are stacked, it is possible to form a fuel cell system wherein, when both the fuel gas and the oxidant gas are supplied to the cell as unhumidified atmospheres, the self-humidification performance of the fuel cell is superior, the removal of a gas humidification module, etc., from the fuel cell system is thus enabled, and the fuel cell is consequently as small and light in weight as possible and is superior in power generation performance.

While preferred embodiments of the present invention have been described in detail hereinabove with reference to the drawings, it will be appreciated that the present invention is by no means limited thereto, various changes may be made within the scope of the invention, and all such changes are intended to be included in the accompanying claims.

1. A membrane electrode assembly comprising:
an electrolyte membrane; and
an anode-side catalyst layer and a cathode-side catalyst layer which are respectively disposed on both sides of the electrolyte membrane and which comprise a catalyst support, in which a catalyst is supported on a conductive support, and a polymer electrolyte, wherein
I/C (ratio of the mass of the polymer ionomer (I) to the mass of the conductive support (C)) of the anode-side catalyst layer is within a range of 1.0 to 2.0,
EW (sulfonic acid equivalent weight) of the anode-side catalyst layer is within a range of 750 to 1,100, and
polymer electrolyte thickness of the anode-side catalyst layer is within a range of 10 nm to 24 nm.

2. The membrane electrode assembly according to claim 1, wherein the thickness of the anode-side catalyst layer is less than the thickness of the cathode-side catalyst layer.

3. The membrane electrode assembly according to claim 2, wherein the thickness of the anode-side catalyst layer is within a range of 10% to 60% of the thickness of the cathode-side catalyst layer.

4. A fuel cell stack comprising a plurality of fuel cells that are stacked, wherein each of the fuel cells comprises the membrane electrode assembly according to claim 1 and gas permeable layers and separators that sandwich the membrane electrode assembly.
